(19) United States
(12) Patent Application Publication
(10) Pub. No.: US 2015/0334471 A1
(43) Pub. Date: Nov. 19, 2015

(54) MULTIPLE SIMULTANEOUS AUDIO VIDEO DATA DECODING

(71) Applicant: ECHOSTAR TECHNOLOGIES L.L.C., Englewood, CO (US)

(72) Inventors: David A. Innes, Littleton, CO (US); Alan Terry Pattison, Castle Rock, CO (US)

(73) Assignee: ECHOSTAR TECHNOLOGIES L.L.C., Englewood, CO (US)

(21) Appl. No.: 14/278,133

(22) Filed: May 15, 2014

(51) Int. Cl. H04N 21/8547; H04N 21/43; H04N 7/56; H04N 21/242; H04L 29/06; H04W 8/08

(52) U.S. Cl. CPC H04N 21/8547; H04L 65/60; H04L 67/42; H04W 8/08; H04N 7/56; H04N 21/242; H04N 21/4307

(57) ABSTRACT

A system includes a server configured to receive a data stream and at least one client device configured to receive the data stream from the server. The server is configured to synchronize playback of a media content instance by the server, one or more of the client devices, or both, in accordance with a timestamp associated with the data stream.

### BACKGROUND

Networked televisions are gaining popularity in homes and businesses. Consumers want to watch recorded shows, live shows, or both, from different locations. In a residential setting, consumers will begin watching a show in one location, such as a family room, and continue watching the show in another location, such as a bedroom. Consumers expect to be able to begin watching the show from the same point from the other location. In a commercial setting, such as a sports bar, a proprietor controls the content displayed on multiple televisions so that the same or different content is displayed on numerous screens. Networking televisions through their set top boxes provides these and other features to residential and commercial consumers.

### BRIEF DESCRIPTION OF THE DRAWINGS

FIG. 1 illustrates an exemplary system for synchronizing playback of a media content instance across multiple devices.

FIG. 2 is a block diagram of an exemplary set top box for synchronizing playback of a media content instance.

FIG. 3 is a flowchart of an exemplary process that may be used to synchronize playback of a media content instance across multiple devices.

### DETAILED DESCRIPTION

Synchronizing playback of media content across different rooms can be challenging. Multiple televisions playing the same video and audio in close proximity out of sync can be a source of annoyance and frustration. One way to relieve such frustration is to synchronize the decoding and playback of the media content instance. An exemplary system for synchronizing decoding and playback of a media content instance includes a server configured to receive a data stream and at least one client device configured to receive the data stream from the server. The client devices and the server each independently decode the data stream before outputting the media content instance to a display device for presentation to a viewer. This independent processing may cause delays relative to the playback of the media content instance on the server, the client devices, or both. Accordingly, the server is configured to synchronize playback of a media content instance across these devices. The synchronization is performed in accordance with a timestamp, such as a presentation timestamp, associated with the data stream. An exemplary method includes receiving the data stream at the server, transmitting the data stream to at least one client device, processing the data stream, and synchronizing playback of a media content instance in accordance with a timestamp associated with the data stream.

The system shown in the FIGS. may take many different forms and include multiple and/or alternate components and facilities. The exemplary components illustrated are not intended to be limiting. Indeed, additional or alternative components and/or implementations may be used.

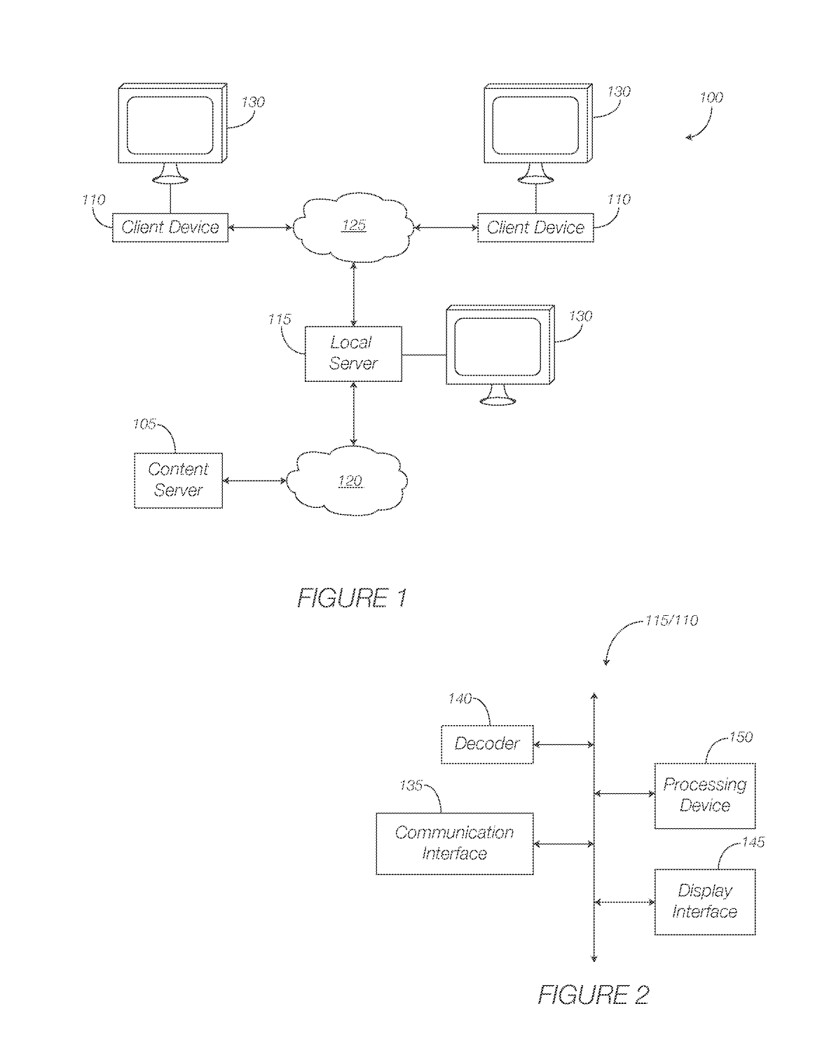

As illustrated in FIG. 1, the system 100 includes a content server 105, at least one client device 110 (only two are shown for purposes of simplicity), and a local server 115. The local server 115 is in communication with the content server 105 over a service provider network 120 and in communication with the client devices 110 over a local network 125. Examples of the local server 115, client device 110, or both, may include a set top box, a game console, a media content streaming device, or the like.

The content server 105 may be configured to provide media content to the local server 115. The content server 105 may access one or more content databases to retrieve a media content instance and transmit the media content instance, as a data stream, to the local server 115. The data stream may include audio, video, or both. Examples of a media content instance, therefore, may include a television show, movie, video, game, song, or the like. The content server 105 may be configured to transmit the data stream to the local server 115 via the content provider network.

Each client device 110 may be configured to decode data streams containing a media content instance. Decoding the data stream may include converting the data stream into a format that can be presented on a display device 130, such as a television, computer monitor, or the like. For instance, as discussed above, the data stream may include audio, video, or both, of the media content instance. Thus, decoding the data stream may include a digital signal processing technique that manipulates the audio and video components of the data stream so that the media content instance may be presented by the display device 130. As discussed in greater detail below, each client device 110 may receive the data stream from the local server 115. Moreover, each client device 110 may be configured to independently decode the data stream relative to both the local server 115 and other client devices 110. Each client device 110 may be configured to receive the data stream through a wired communication interface 135, a wireless communication interface 135, or both. The data stream may be received at each client device 110 through the local network 125.

The local server 115 may be configured to receive the data stream from the content server 105 over the service provider network 120. The local server 115 may be configured to process the data stream independently of the processing performed by one or more of the client devices 110. As discussed above, processing the data stream may include, e.g., decoding the data stream to a format that may allow the media content instance to be played on, e.g., a television or other display device 130. In some possible implementations, the local server 115 may be configured to receive the data stream over the content provider network through a wireless communication interface 135, a wired communication interface 135, or both. Moreover, the local server 115 may be configured to transmit the data stream to one or more client devices 110 over the local network 125. The local server 115 may communicate over the local network 125 through a wireless or wired communication interface 135. Because the client devices 110 may process the data stream independently from the local server 115, the local server 115 may transmit the unprocessed data stream to one or more client devices 110 over the local network 125.

The local server 115 may be further configured to synchronize decoding, playback, or both, of the media content instance across multiple devices, such as the client devices 110. In one possible implementation, the local server 115 may synchronize decoding and playback of the media content instance in accordance with a timestamp associated with the data stream. The timestamp may, in some instances, be embedded in the data stream as metadata. The timestamp may indicate the time at which certain portions of the media content instance are to be played. For instance, the timestamp may include a presentation timestamp (PTS) otherwise used to synchronize audio and video portions of the media content instance with one another. That is, the presentation timestamp may be further used to synchronize the decoding and playback of the media content instance across multiple devices. The local server 115 may be configured to determine, based on the presentation timestamp, whether the playback of the media content instance by one of the client devices 110 lags the playback of the media content instance by the local server 115 or another of the client devices 110. Likewise, the local server 115 may be configured to determine, based on the presentation timestamp, whether the playback of the media content instance by the local server 115 lags the playback of the media content instance by one or more of the client devices 110. If any lag is detected, the local server 115 may be configured to slow its decoding and playback of the media content instance, or in some instances, command one or more client devices 110 to speed up their decoding of the media content instance until the playback of the media content instance is synchronized across all devices, including the client devices 110 and the local server 115, playing the media content instance. Alternatively or in addition, the server 115 could speed up its decoding of the media content instance if the playback by the server 115 lags relative to the client devices 110.

FIG. 2 is a block diagram of an exemplary local server 115, client device 110, or both. While the discussion of FIG. 2 is generally in the context of the local server 115, the diagram shown in FIG. 2 may apply to one or more client devices 110 or any other device that processes the data stream and outputs the processed data stream to a display device 130 to present the media content instance. As shown, the local server 115 includes a communication interface 135, a decoder 140, a display interface 145, and a processing device 150.

The communication interface 135 may be configured to facilitate wired and/or wireless communication over the local network 125, the content provider network, or both, using any number of communication protocols such as WiFi, Bluetooth®, Ethernet, or the like. The communication protocols implemented by the communication interface 135 may include wired communication protocols, wireless communication protocols, or both. The communication interface 135, therefore, may be configured to receive the data stream from the content server 105 over the content provider network as well as transmit the data stream to the client devices 110 over the local area network.

The decoder 140 may be configured to process the data stream received via the communication interface 135. The data stream may be encoded by the content server 105 or another device before the data stream is transmitted over the content provider network. The decoder 140 may be configured to decode the encoded data stream. The decoder 140 may be configured to decode the data stream in accordance with a format that may be output to the display device 130.

The display interface 145 may be configured to connect the local server 115 to the display device 130. The display interface 145 may comply with any number of analog or digital display protocols. Examples of display protocols may include a High-Definition Multimedia Interface (HDMI), a Digital Visual Interface (DVI), a Composite video interface, an S-Video interface, a Component video interface, etc.

The processing device 150 may be configured to facilitate the transmission of the data stream to one or more client devices 110, and in some instances, synchronize the decoding and playback of the media content instance across multiple devices, including multiple client devices 110 and the local server 115. For instance, the processing device 150 may synchronize decoding and playback of the media content instance in accordance with a timestamp associated with the data stream. As discussed above, the timestamp may be embedded in the data stream as metadata, such as the presentation timestamp, indicating the time at which certain portions of the media content instance are to be played. The processing device 150 may be configured to determine, based on the presentation timestamp, whether the playback of the media content instance by one of the client devices 110 lags the playback of the media content instance by the local server 115 or another of the client devices 110. Likewise, the processing device 150 may be configured to determine, based on the presentation timestamp, whether the playback of the media content instance by the local server 115 lags the playback of the media content instance by one or more of the client devices 110. If any lag is detected, the processing device 150 may be configured to slow its playback of the media content instance, or in some instances, command, via the communication interface 135, one or more client devices 110 to slow their playback of the media content instance until the playback of the media content instance is synchronized across all devices, including the client devices 110 and the local server 115, playing the media content instance. Alternatively or in addition, the processing device 150 could speed up the decoding of the media content instance if the playback by the server 115 lags relative to the client devices 110 or command the client devices 110 to speed up their decoding of the media content instance if the playback on the client devices 110 lags relative to the server 115.

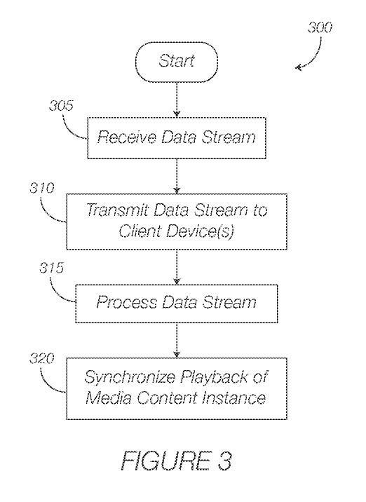

FIG. 3 is a flowchart of an exemplary process 300 that may be implemented by one or more components of the system 100 of FIG. 1.

At block 305, the local server 115 may receive the data stream from the content server 105 over, e.g., the service provider network 120. In some possible implementations, the local server 115 may query the content server 105 for a particular media content instance, and the content server 105 may transmit the data stream associated with the requested media content instance in response to the query from the local server 115. The data stream may be received through a wired or wireless communication protocol.

At block 310, the local server 115 may transmit the data stream to one or more client devices 110. The data stream may be transmitted to the client devices 110 over, e.g., the local network 125. The data stream may be transmitted to one or more client devices 110 through a wired communication protocol, a wireless communication protocol, or both.

At block 315, the local server 115 and any client devices 110 that received the data stream at block 310 may independently process the data stream. As discussed above, processing the data stream may include converting the data stream into a format that can be presented on a display device 130, such as a television, computer monitor, or the like. Specifically, in one possible approach, the data stream may be encoded by the content server 105 or another device before the data stream is transmitted to the local server 115 over the content provider network. Thus, processing the data stream may include decoding the encoded version of the data stream. The data stream may be decoded in accordance with a format that may be output to and presented on the display device 130.

At block 320, the local server 115 may synchronize decoding, playback, or both of the media content instance across the local server 115 and one or more of the client devices 110 that are simultaneously presenting the same media content instance on multiple display devices 135. The local server 115 may synchronize decoding and playback of the media content instance according to a timestamp associated with the data stream. An example timestamp may include the presentation timestamp, which may also be used for synchronizing the audio and video components of the media content instance. The local server 115 may determine whether the playback of the media content instance by one of the client devices 110 or the local server 115 lags the playback of the media content instance by any other device, including other client devices 110 or the local server 115. If a lag is discovered, the local server 115 may delay its own playback of the media content instance until synchronized, as indicated by the presentation timestamp, with one or more of the client devices 110. Alternatively or in addition, the local server 115 may command one or more of the client devices 110 to delay playback until synchronized, again as indicated by the presentation timestamp. Alternatively or in addition, the server 115 may speed up the decoding of the media content instance if the playback by the server 115 lags relative to the client devices 110 or command the client devices 110 to speed up their decoding of the media content instance if the playback on the client devices 110 lags relative to the server 115.

In general, the computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system comprising:
a server configured to receive a data stream; and
a client device configured to receive the data stream from the server,
wherein the server is configured to synchronize playback of a media content instance by the server and the client device in accordance with a timestamp associated with the data stream.

2. The system of claim 1, wherein the data stream includes the media content instance.

3. The system of claim 1, wherein the server and the client device are configured to independently process the data stream.

4. The system of claim 1, wherein the server is configured to determine whether the playback of the media content instance by the client device lags the playback of the media content instance by the server.

5. The system of claim 1, wherein the client device is configured to determine whether the playback of the media content instance by the server lags the playback of the media content instance by the client device.

6. The system of claim 1, wherein the server is configured to receive the data stream through at least one of a wired communication interface and a wireless communication interface.

7. The system of claim 1, wherein the client device is configured to receive the data stream through at least one of a wireless communication interface and a wired communication interface.

8. A system comprising:
a server configured to output a data stream;
a first client device in communication with the server and configured to process the data stream; and
a second client device in communication with the server and configured to process the data stream,
wherein the server is configured to synchronize playback of a media content instance by the first client device and the second client device in accordance with a timestamp associated with the data stream.

9. The system of claim 8, wherein the data stream includes the media content instance.

10. The system of claim 8, wherein the first client device and the second client device are configured to independently decode the data stream.

11. The system of claim 8, wherein the server is configured to determine whether the playback of the media content instance by the first client device lags relative to the playback of the media content instance by the second client device.

12. The system of claim 8, wherein the server is configured to receive the data stream through a wired communication interface.

13. The system of claim 8, wherein the server is configured to receive the second data stream through a wireless communication interface.

14. The system of claim 8, wherein the server is configured to transmit the data stream through at least one of a wired and wireless communication interface.

15. The system of claim 8, wherein at least one of the first client device and the second client device is configured to receive the data stream through at least one of a wired and wireless communication interface.

16. A method comprising:
receiving, at a server, a data stream including a media content instance;
transmitting the data stream to at least one client device;
processing the data stream; and
synchronizing playback of a media content instance in accordance with a timestamp associated with the data stream.

17. The method of claim 16, wherein processing the data stream incudes independently decoding the data stream by the server and the at least one client device.

18. The method of claim 16, wherein synchronizing playback of the media content instance includes determining whether the playback of the media content instance by the at least one client device lags relative to the playback of the media content instance by the server.

19. The method of claim 16, wherein the data stream is received by the server through at least one of a wired and wireless communication interface.

20. The method of claim 16, wherein the data stream is received by the at least client device through at least one of a wired and wireless communication interface.
